(19) United States
(12) Patent Application Publication
(10) Pub. No.: US 2017/0177497 A1
(43) Pub. Date: Jun. 22, 2017

(54) COMPRESSED CACHING OF A LOGICAL-TO-PHYSICAL ADDRESS TABLE FOR NAND-TYPE FLASH MEMORY

(71) Applicant: QUALCOMM INCORPORATED, SAN DIEGO, CA (US)

(72) Inventors: DEXTER TAMIO CHUN, SAN DIEGO, CA (US); HYUNSUK SHIN, SAN DIEGO, CA (US)

(21) Appl. No.: 14/976,537

(22) Filed: Dec. 21, 2015

(51) Int. Cl. G06F 12/10; G06F 12/08

(52) U.S. Cl. CPC G06F 12/1009; G06F 12/0802; G06F 12/1081; G06F 2212/70; G06F 2212/7201

(57) ABSTRACT

Systems and methods are disclosed for providing logical-to-physical address translation for a managed NAND flash storage device. One embodiment is a system comprising a system on chip (SoC) electrically coupled to a volatile memory device. A direct memory access (DMA) controller is electrically coupled to the SoC. The DMA controller receives a logical address to be translated to a physical address associated with a managed NAND flash storage device. A cache controller is configured to fetch from the volatile memory device a portion of a logical-to-physical (L2P) address table comprising a compressed version of a L2P mapping for the logical address. A compression block is configured to decompress the compressed version of the L2P mapping to determine the physical address corresponding to the logical address.

### DESCRIPTION OF THE RELATED ART

Flash storage performance is becoming increasingly demanding. Compact consumer electronics such as smartphones, tablets, and gaming devices require cost effective and low power storage solutions. NAND flash storage devices include both managed and direct. Managed NAND flash storage devices include an independent storage controller chip that provides a flash translation layer (FTL) so that the application processor system on chip (SoC) does not need to handle this. Direct NAND flash storage does not have a separate storage controller chip and, therefore, the SoC performs the FTL function. Examples of managed NOT AND (NAND) flash storage devices include embedded MultiMediaCards (eMMC), universal flash storage (UFS), External Serial Advanced Technology Attachment (eSATA), ball grid array (BGA) SATA, Universal Serial Bus (USB) drives, Secure Digital (SD) cards, Non-Volatile Memory Express (NVMe) cards, and compact flash cards. Examples of direct (non-managed) NAND flash storage include toggle-NAND and Open NAND flash interface (ONFI) NAND. NAND devices are popular for mobile applications because they are low cost and low power.

Existing NAND flash storage devices rely on large flash translation layer (FTL) logical to physical (L2P) address translation tables contained within the NAND flash memory, and cache only a small portion of the L2P tables in on-chip static random access memory (SRAM). In managed and direct NAND flash storage, read and write accesses from the application processor consist of logical addresses that are translated to physical NAND addresses using information from the FTL L2P table. This leads to long delays (on the order of tens of microseconds) when reading the FTL table entries from NAND memory, degrading the overall performance of these types of storage. Thus, the penalty for low cost and low power consumption in NAND memory devices is a reduction in memory access time performance.

### SUMMARY OF THE DISCLOSURE

Systems and methods are disclosed for providing logical-to-physical address translation for a managed NAND flash storage device. One embodiment is a system comprising a system on chip (SoC) electrically coupled to a volatile memory device. A direct memory access (DMA) controller is electrically coupled to the SoC. The DMA controller receives a logical address to be translated to a physical address associated with a managed NAND flash storage device. A cache controller is configured to fetch from the volatile memory device a portion of a logical-to-physical (L2P) address table comprising a compressed version of a L2P mapping for the logical address. A compression block is configured to decompress the compressed version of the L2P mapping to determine the physical address corresponding to the logical address.

Another embodiment is method for providing logical-to-physical address translation for a managed NAND flash storage device. The method comprises: receiving, from a program executing on a system on chip (SoC), a logical address to be translated to a physical address associated with a managed NAND flash storage device electrically coupled to the SoC; fetching, from a volatile memory device electrically coupled to the SoC, a portion of a logical-to-physical (L2P) address table comprising a compressed version of a L2P mapping for the logical address; and decompressing the compressed version of the L2P mapping to determine the physical address corresponding to the logical address.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for providing compressed caching of the logical-to-physical (L2P) address table for NAND-type flash memory.

FIG. 2 is a flowchart illustrating an embodiment of a method implemented in the system of FIG. 1 for providing compressed caching of the L2P address table.

FIG. 3 is a data diagram illustrating NAND pages for an exemplary managed NAND flash storage device organized into logical groups.

FIG. 4 is a data diagram illustrating the compression of the L2P addresses for an exemplary logical group.

FIG. 5 is a data diagram illustrating an embodiment of a logical group tag format.

FIG. 6 is a flowchart illustrating an embodiment of a method implemented in the system of FIG. 1 for initializing the managed NAND flash storage device.

FIG. 7 is a data diagram illustrating an exemplary cache space in the DRAM of FIG. 1.

FIG. 8 is a data diagram illustrating an exemplary logical group lookup table corresponding to the cache space of FIG. 7.

FIG. 9 is a data diagram illustrating the structure and operation of an embodiment of the cache free list in FIG. 1.

FIG. 10 is a flowchart illustrating an embodiment of a method implemented in the system of FIG. 1 for managing logical groups in response to a NAND read operation.

FIG. 11 is a flowchart illustrating another embodiment of a method for implemented in the system of FIG. 1 for managing logical groups in response to a NAND write operation.

FIG. 12a illustrates an exemplary DRAM cache space in a first operational state.

FIG. 12b illustrates an exemplary logical group lookup table corresponding to the DRAM cache space of FIG. 12a.

FIG. 13a illustrates the DRAM cache space of FIG. 12a in a second operational state.

FIG. 13b illustrates the logical group lookup table in the second operational state.

FIG. 14a illustrates the DRAM cache space in a third operational state.

FIG. 14b illustrates the logical group lookup table in the third operational state.

FIG. 15a illustrates the DRAM cache space in a fourth operational state.

FIG. 15b illustrates the logical group lookup table in the fourth operational state.

FIG. 16a illustrates the DRAM cache space in a fifth operational state.

FIG. 16b illustrates the logical group lookup table in the fifth second operational state.

FIG. 17a illustrates the DRAM cache space in a sixth operational state.

FIG. 17b illustrates the logical group lookup table in the sixth second operational state.

FIG. 18a illustrates the DRAM cache space in a seventh operational state.

FIG. 18b illustrates the logical group lookup table in the seventh second operational state.

FIG. 19 is flowchart illustrating an embodiment of a method implemented by the cache controller of FIG. 1.

FIG. 20 is a block diagram of an embodiment of a portable computer device for incorporating the systems and methods of FIGS. 1 - 19.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

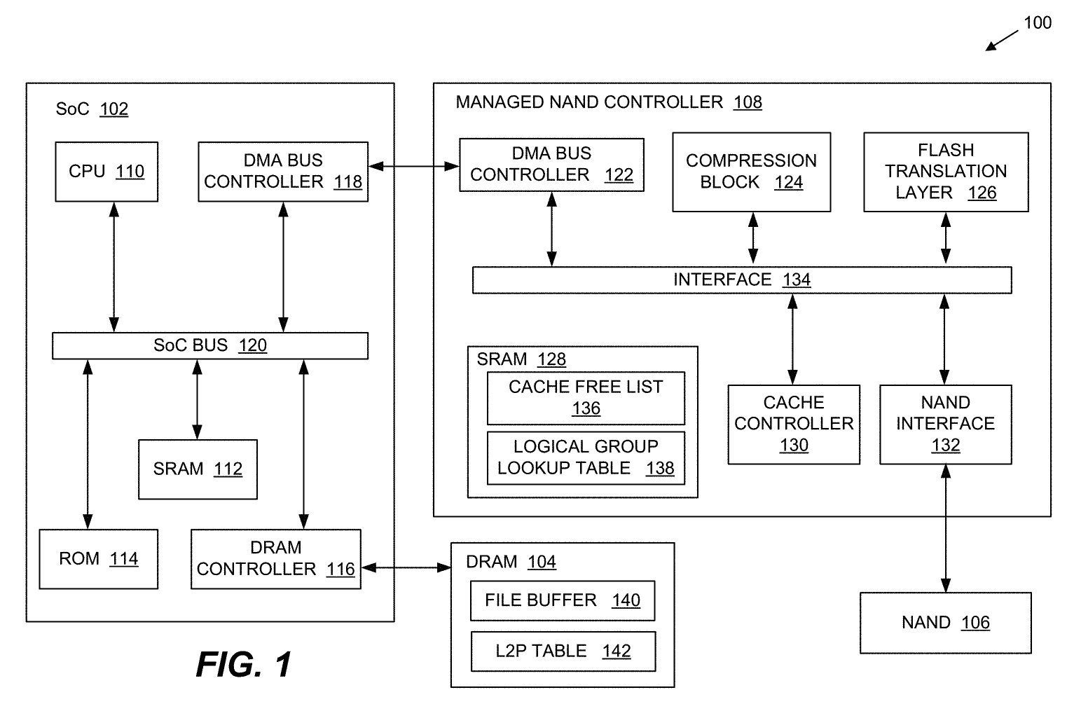

FIG. 1 illustrates a system 100 for providing compressed caching of a logical-to-physical to-physical (L2P) address table for a managed NAND flash storage device (e.g., NAND 106). NAND 106 comprises NAND-type flash memory. In an embodiment, NAND 106 may comprise MultiMediaCards (eMMC), universal flash storage (UFS), External Serial Advanced Technology Attachment (eSATA), ball grid array (BGA) SATA, Universal Serial Bus (USB) drive, Secure Digital (SD) card, universal subscriber identity module (USIM) card, and compact flash card.

The system 100 may be implemented in any computing device, including a personal computer, a workstation, a server, and a portable computing device (PCD), such as a cellular telephone, a smartphone, a portable digital assistant (PDA), a portable game console, or a tablet computer. As illustrated in the embodiment of FIG. 1, the system 100 comprises a system on chip (SoC) 102 electrically coupled to a managed NAND controller 108 and a dynamic random access memory (DRAM) 104. The managed NAND controller 108 provides direct memory access to the NAND 106.

The SoC 102 comprises one or more processing units (e.g., central processing unit (CPU) 110, a graphics processing unit (GPU), digital signal processing unit(s), etc.), a direct memory access (DMA) bus controller 118, a DRAM controller 116, and on-board memory (e.g., a static random access memory (SRAM) 112, and read only memory (ROM) 114, etc.) interconnected by a SoC bus 120. The DMA bus controller 118 is electrically coupled to the managed NAND controller 108 and controls memory access (e.g., read and/or write operations) to the NAND 106. The DRAM controller 116 is electrically coupled to DRAM 104 and controls read/write access to DRAM 104.

The managed NAND controller 108 comprises a DMA bus controller 122 electrically coupled to the SoC 102 and a NAND interface 132 electrically coupled to the NAND 106. As described below in more detail, the managed NAND controller 108 enables compressed caching of the NAND logical-to-physical (L2P) address table 142. In an embodiment, the managed NAND controller 108 further comprises a cache controller 130, a compression block 124, a flash translation layer (FTL) 126 executing on a microcontroller, and SRAM 128 interconnected via an interface 134. In general, the cache controller 130 is configured to compress the L2P address table 142 in DRAM 104. The cache controller 130 configures and manages (e.g., in SRAM 128) various data structures (e.g., a cache free list 136 and a logical group (LG) lookup table 138) used to implement the compressed caching of the L2P address table 142 in DRAM 104. The managed NAND embodiment of FIG.1 is an example of a managed NAND storage system using a managed NAND controller 108 that is external to the SoC 102. It should be appreciated that in another embodiments, the circuitry and functions within the managed NAND controller 108 of FIG.1 may be integrated into the SoC 102, leaving only the DRAM 104 and NAND 106 external to the SoC 102.

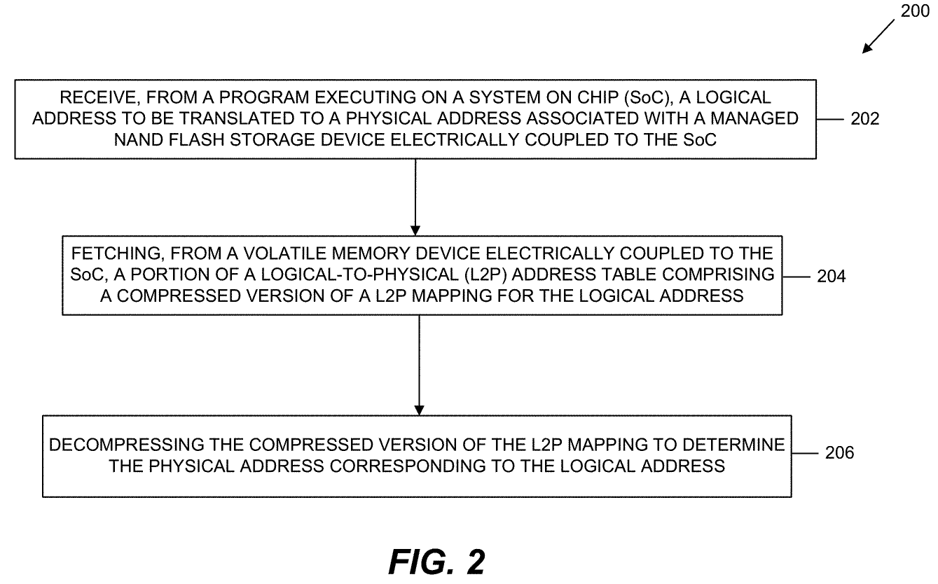

FIG. 2 illustrates an embodiment of a method 200 implemented in the system 100 for providing compressed caching of the L2P address table 142. At block 202, a program executing on, for example, the CPU 102, may specify a logical address to be translated to a physical address associated with NAND 106. The logical address may be received, in response to a NAND read and/or write operation, via the DMA bus controller 122. The L2P translation for the received logical address may be performed by the flash translation layer (FTL) 126 executing on a microcontroller. FTL 126 may lookup a portion of the L2P address table 142 stored in DRAM 104. As described below in more detail, the portion of the L2P address table 142 may comprise a compressed subset of all the logical-to-physical address mappings for the NAND 106.

At block 204, the cache controller 130 may fetch the portion of the L2P address table 142 from DRAM 104 via, for example, the DMA bus controller 122. The fetched portion may be decompressed by the compression block 124 to extract the L2P mapping, which allows FTL 126 to determine the physical address. It should be appreciated that FTL 126 may be integrated with a microcontroller and/or cache controller 130. In the case of a read operation, after the physical address is obtained, NAND 106 may be issued a read command. In response, the desired program data may be returned via NAND interface 132. The data may be provided to the program via DMA bus controller 122 (in managed NAND controller 108), DMA bus controller 118 residing on SoC 102, SoC bus 120, DRAM controller 104, and deposited into the program's file buffer 140 residing in DRAM 104.

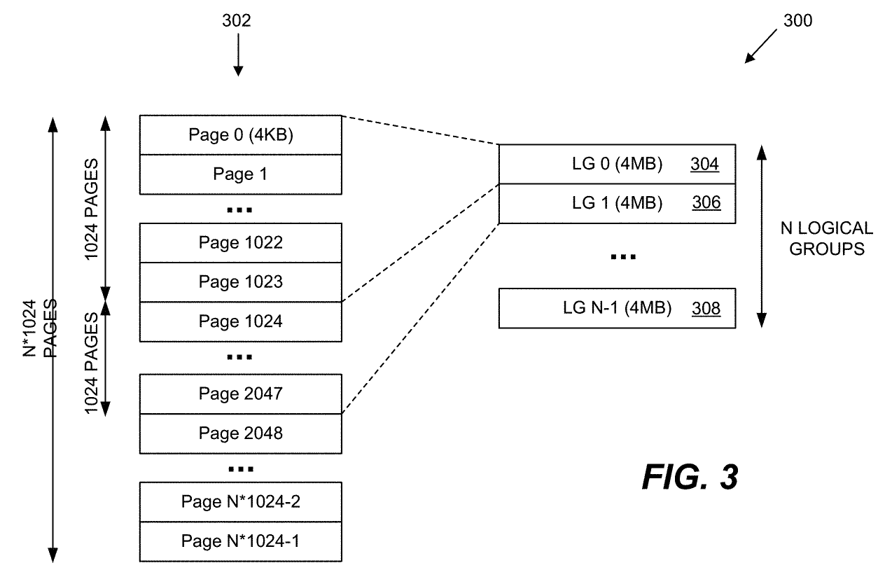

FIGS. 3-5 illustrates an exemplary embodiment of a cache structure for storing a compressed version of L2P addresses in DRAM 104. The memory map 302 in FIG. 3 represents the memory space of an exemplary NAND flash storage device 106. The NAND flash storage device 106 may comprise a plurality of fixed-size blocks or pages of data, which are virtually organized into N logical groups. In the embodiment of FIG. 3, each page 302 comprises 4 KB of data with each logical group comprising 1024 pages (resulting in each logical group comprising 4 MB of data). For example, Page 0-Page 1023 may be virtually organized into a logical group 304 (LG0). Page 1024-Page 2047 may be virtually organized into a logical group 306 (LG1), and so on, defining a last logical group 308.

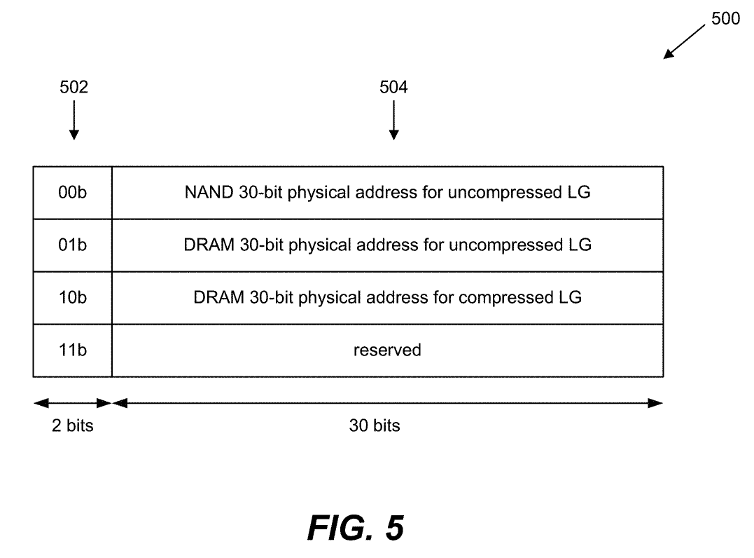

Each logical group of pages 302 may have an associated tag for configuring and managing the logical group (LG) lookup table 138 (FIG. 1). FIG. 5 is a data diagram illustrating an embodiment of a logical group tag format 500. In the embodiment of FIG. 5, each 32-bit tag describes where the logical group is located (e.g., in DRAM 104 or NAND 106) and whether the logical group is compressed or uncompressed. A value of “00b” in the 2-bit indicator field 502 indicates that the logical group is uncompressed and is located in NAND 106. A value of “01b” in the 2-bit indicator field 502 indicates that the logical group is uncompressed and is located in DRAM 104. A value of “10b” in the 2-bit indicator field 502 indicates that the logical group is compressed and is located in DRAM 104. The 30-bit field 504 may specify a NAND or DRAM physical address.

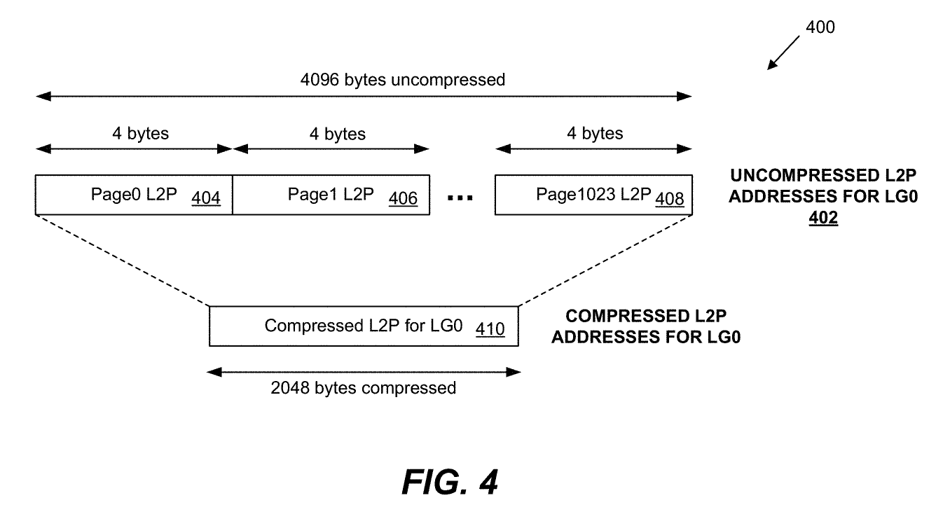

FIG. 4 illustrates compression of an exemplary logical group 400 (LG 0) by, for example, compression block 124. The uncompressed L2P addresses 402 for all 1024 pages in the logical group 400 occupy a total of 4096 bytes. The L2P addresses for Page 0, Page 1, and Page 1023 are shown at reference numerals 404, 406, and 408, respectively. The compression block 124 may compress the L2P addresses for logical group 400 into a compressed version 410 comprising, for example, 2048 bytes or less. In some cases, it may not be possible to compress the logical group L2P addresses down to 2048 bytes, in which case they may remain uncompressed. Compression and decompression may be performed on an entire logical group 400 (e.g., all 1024 pages L2P within it) in order to achieve a suitable compression ratio so that most of the logical group successfully fits within 2 KB. The choice of lossless compression algorithm is flexible. For example, in an embodiment, the compression algorithm may comprise any of the Lempel-Ziv (LZ) variations or it may use less complex schemes. The decompression operation may be much faster than the compression operation, and this asymmetry may be well suited to the way LG L2P caching operates by affording improved read latency.

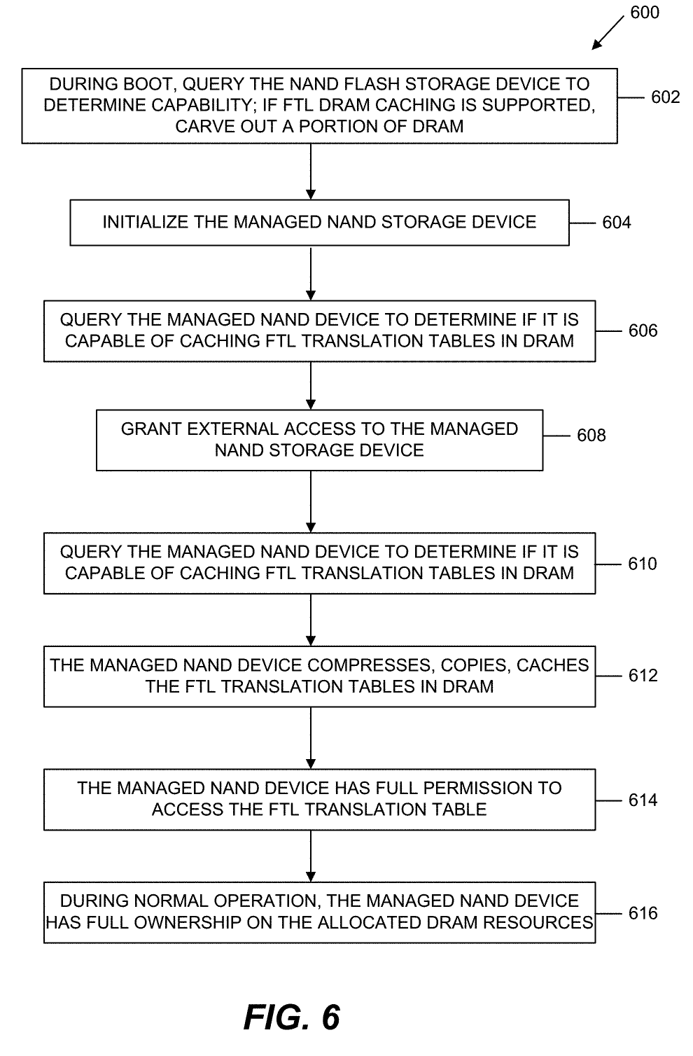

FIG. 6 is a flowchart illustrating an embodiment of a method 600 implemented in the system of FIG. 1 for initializing the managed NAND flash storage device 106. During a boot of the system 100, initialization software running on the CPU 110 (e.g., host software or other hardware assigned to perform system management and initialization) may query (block 602) the NAND 106 to determine, for example, device capability and whether FTL DRAM sharing is supported. If FTL DRAM sharing is supported, the host may carve out a portion of system DRAM 104 for use by managed NAND flash storage device 106. At block 604, the host may initialize the managed NAND flash storage device 106. During boot, the system 100 may be operating with FTL in NAND 106. At block 606, the host may query the managed NAND flash storage device 106 to determine if it is capable of caching the FTL translation tables in DRAM 104. At block 608, the host may grant external access to the managed NAND flash storage device 106 and allow it to read and/or write the section of system DRAM 104 that was carved out in block 602. The host may provide the managed NAND flash storage device 106 with an amount of DRAM that is allocated for FTL translation tables. At block 610, the managed NAND flash storage device 106 may compress, copy, and/or cache a part or all of the FTL translation table into DRAM 104 depending on the available DRAM resources. It should be appreciated that notification and other control functions between the host and the managed NAND flash storage device 106 may be completed using commands, responses, etc. over a convention storage interface bus. At block 612, a complete or partial FTL translation table may exist in the host's DRAM 104 and in block 614 the managed NAND flash storage device 106 has full permission to access the table. At block 616, during normal operation, the managed NAND flash storage device 106 has full ownership on the allocated DRAM resources. If the allocated DRAM space is not enough to contain the entire FTL translation table, the managed NAND flash storage device 106 may page in/out certain portion(s) of logical groups in DRAM 104 and maintain other logical groups in NAND.

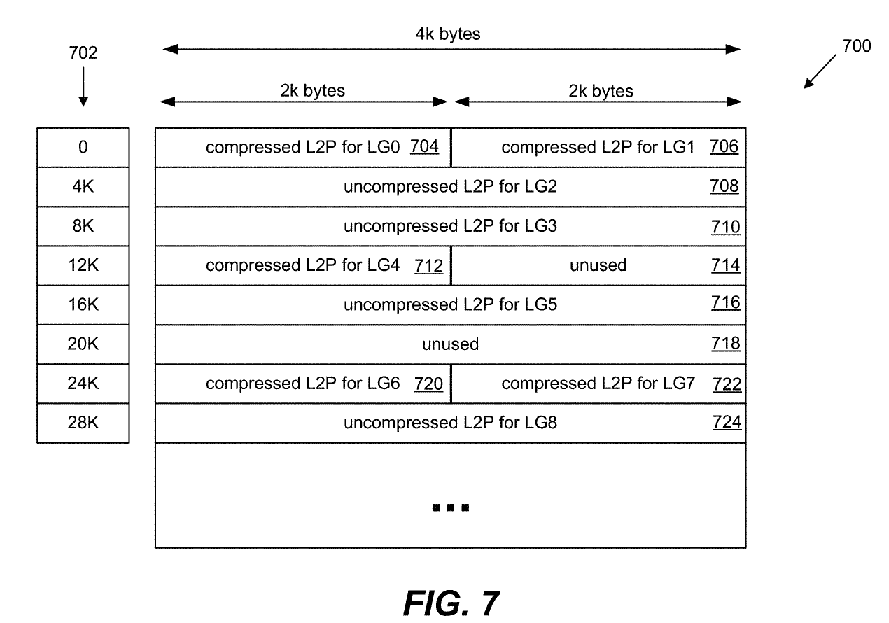

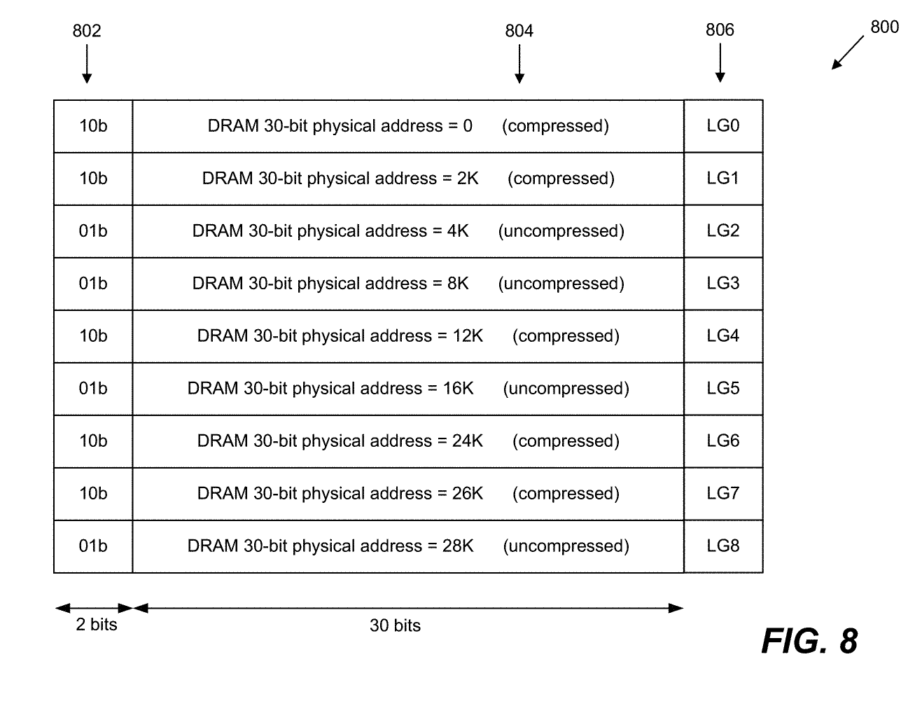

FIGS. 7 & 8 illustrate an embodiment of method for configuring and managing the DRAM L2P table 142 cache space via the LG lookup table 138. FIG. 7 illustrates a DRAM cache space 700 corresponding to L2P table 142. FIG. 8 illustrates an LG lookup table 800 implemented using SRAM corresponding to the LG lookup table block 138 for locating the logical group L2P entries (e.g., blocks 704, 706, 708, etc.) in the DRAM cache space 700. It should be appreciated that each row represented in the LG lookup table 800 is a tag comprising the indicator field 802 (same as 502) and a 30-bit physical address 804 (same as 504) as described in FIG.5. The DRAM cache space may or may not be fully used, as some of the LG L2P mappings may also reside in the managed NAND flash storage device 106. DRAM cache space 700 may be used to hold either compressed L2P LG (which occupies 2 KB) or uncompressed L2P LG (which occupies 4 KB). The starting physical address for each row of the table is labeled 702. Compressed or uncompressed L2P LG entries are stored within any available spaces within DRAM cache space 700. LG lookup table 800 comprises a tag for every LG. The tags may be arranged linearly beginning from LG0 in the first row of LG lookup table 800, followed by LG1 in the second row, LG2 in the third row, etc. The LG is labeled according to column 806. During a data read access, the FTL 126 determines the physical address within the NAND flash that contains the data. The FTL 126 is provided a logical page address but must find the physical page address using the L2P table 142. In operation, the LG containing the logical page address is determined. LG0 may correspond to pages 0-1023, LG1 to pages 1024-2047, and so forth. To locate a specific LG L2P, the cache controller 130 may read the row corresponding to the desired LG in the LG lookup table 800.

For example, to read logical page address 1025, the cache controller 130 will look at LG1 in the LG lookup table 800. It will look at the indicator field 802 to determine if the LG L2P is compressed in cache, uncompressed in cache, or non-cached (located in NAND). The cache controller 130 may also look at the physical address field 804. If the indicator field 802 is “00” then the FTL 126 will use the physical address 804 to read from the NAND flash and obtain the LG. If the indicator field 802 is either “01” or “10” then the cache controller 130 will use the physical address 804 to read from the DRAM cache space 700. Again, using logical page address 1025 as an example, LG1 in the LG lookup table 800 has indicator field 802=“10” (compressed) and physical address 804=2048. The cache controller 130 will then read the compressed LG L2P for LG1 706 in DRAM cache space 700. Since each row of DRAM cache space 700 consists of 4K bytes, physical address 2048 corresponding to LG1 L2P 706 begins at the second (right hand) half of the first row. There may be unused portions 714 and 718 portions of DRAM cache space 700. It should be appreciated that the ordering of the LG L2P need not be sequentially ascending. Furthermore, in an embodiment, an uncompressed L2P LG (which occupies 4K bytes) may be row-aligned (starts at any multiple of 4096).

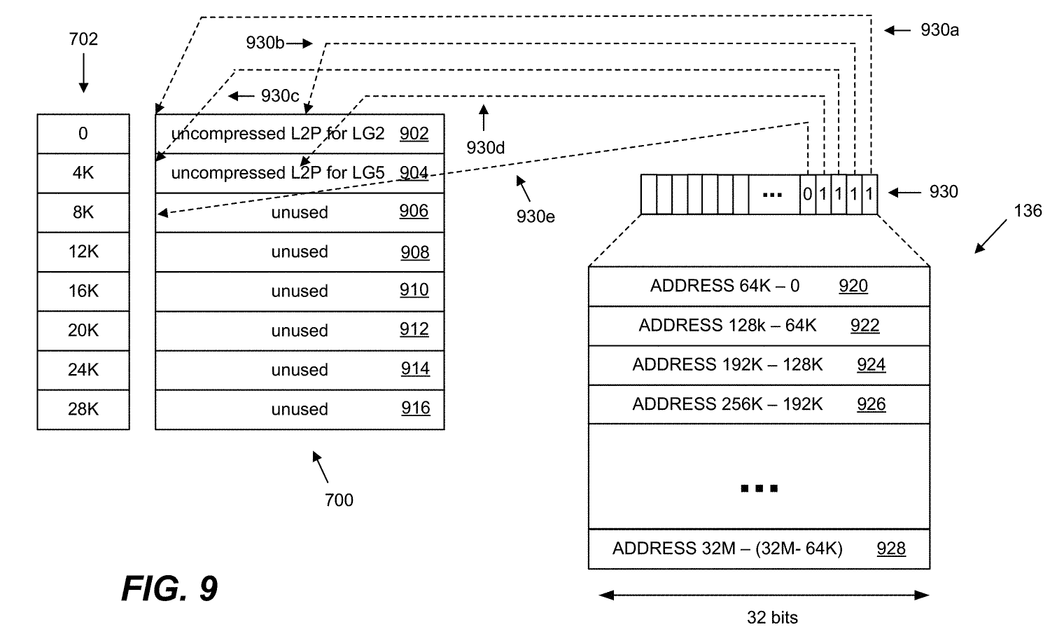

FIG. 9 illustrates the structure and operation of an embodiment of a method for configuring and managing the cache free list 136 stored in SRAM 128. The cache free list 136 maintains a 1-bit field 930 for each 2 KB of DRAM cache space 700. The cache free list 136 may be configured with a plurality of 32-bit rows (920, 922, 924, 926, 928). In this embodiment, each row comprises 32-bits with each bit representing 2 KB of DRAM cache space 700. Therefore, each row represents 64 KB of cache space 700. The first row 920 corresponds to the first 64 KB, the second row 922 corresponds to the next 64 KB, and so forth. If the free bit 930 is “1”, then the corresponding 2 KB of DRAM cache space is in use. If the free bit 930 is “0”, then the corresponding 2 KB of DRAM cache space is free. When a new logical group needs to be cached, the cache controller 130 may search the cache free list 138 for an available cache address. The position (e.g., row and column) of the bit in the cache free list 138 may determine the starting address of the free 2 KB block in the cache. The cache controller 130 may assign the new logical group to that portion of the DRAM cache space 700. The address for each 4 KB row within the DRAM cache space is labeled 702 in FIG. 7.

As illustrated in the embodiment of FIG. 9, for a compressed logical group, 2 KB is used, so any free bit will suffice. For an uncompressed logical group, 4 KB is needed, so two adjacent free bits are used. In this example, the least significant bit of the first row 920 is expanded and labeled 930a and corresponds to address 0 of DRAM cache space 700. The next least significant bit labeled 930b corresponds to address 2K, and the next bit after that labeled 930c corresponds to address 4K, and the next 930d corresponds to 6K, and the next 930e corresponds to 8K, and so forth. It should be appreciated that address 0 and 2K in this example contain an uncompressed L2P LG2. LG2 does not correspond to the lowest logical address (LG0 is), so this example shows that various LG in either compressed or uncompressed form may occupy any portion of the DRAM cache space 700 regardless of their address. On the other hand, the free list 136 may be strictly organized by ascending address, where the least significant bit of the first row references the beginning of DRAM cache space 700, and the most significant bit of the last row references the last 2 KB of DRAM cache space 700. It should be appreciated that this may facilitate rapid searching of the free list 136 to locate space. The free list 136 may be updated whenever occupancy changes within the DRAM cache space 700.

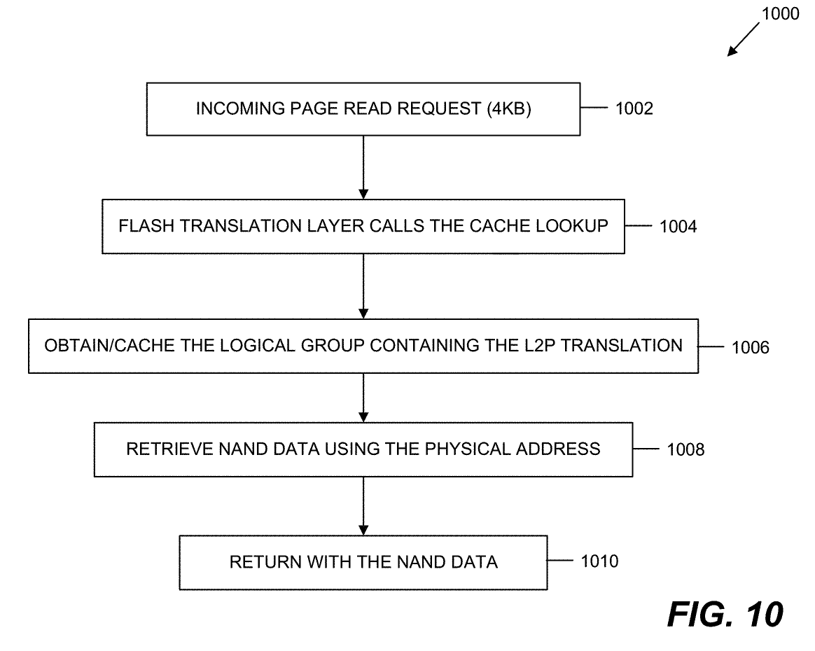

FIG. 10 is a flowchart illustrating an embodiment of a method implemented in the system of FIG. 1 for managing logical groups in response to a NAND read operation. At block 1002, the managed NAND controller 108 receives an incoming page read request via the DMA bus controller 122. At block 1004, the flash translation layer 126 calls the cache lookup. The logical page address provided in the read request will determine which LG the page address belongs to. The LG number corresponding to the page address is looked up in the LG lookup table 800. This reveals the indicator field 802 and physical address 804 which can be used to retrieve the LG. At block 1006, the logical group containing the L2P translation is obtained, determined, and/or cached. Note that if the LG is compressed, this block may include decompression prior to obtaining the L2P address translation for the page. Also, if the LG L2P was retrieved from NAND (because the indicator field 802 was “00”), then the LG L2P may be cached by compressing it and then storing it into the DRAM cache space 700, updating the free list 136, and updating the LG lookup table 800 (both the indicator field 802 and the physical address 804 for the LG will be revised). By doing so, subsequent reads to any of the 1024 pages within the newly cached LG will be faster since they are in DRAM cache space 700. At block 1008, the NAND data is retrieved using the physical address from the L2P translation. At block 1010, the NAND data may be returned to the requesting program.

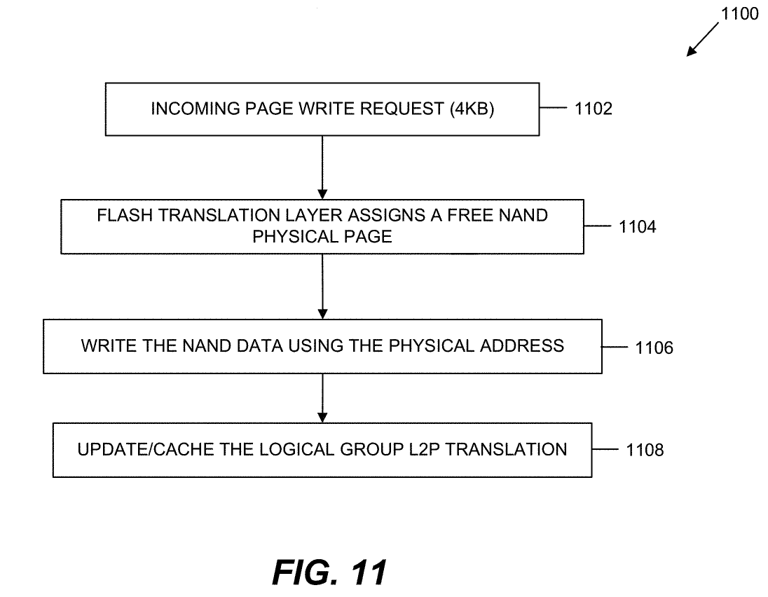

FIG. 11 is a flowchart illustrating another embodiment of a method for implemented in the system of FIG. 1 for managing logical groups in response to a NAND write operation. At block 1102, the managed NAND controller 108 receives an incoming page write request via the DMA bus controller 122. At block 1104, the flash translation layer 126 assigns a free NAND physical page and writes the NAND data using the physical address (block 1106). At block 1108, the cache controller 130 updates and/or caches the logical group L2P translation. The newly assigned physical address for the newly written page will be inserted into the LG belonging to that logical page write address. If any of the other 1024 pages belonging to this LG are already in use, then the newly written page L2P is first inserted into the correct position in the L2P for the other pages as described in LG format 400 in FIG. 4. If this LG is completely unused, then the newly written page L2P may be inserted into the correct position and all of the other page L2P in LG format 400 in FIG.4 may remain zero. A compression of the LG may be attempted and, if compressible, may be stored into DRAM cache 700 occupying 2 KB. If non-compressible, it may be stored into DRAM cache 700 occupying 4 KB. Free space within DRAM cache 700 to store the LG may be found by consulting the free list 136. Management of free space may occur in the background performed by the FTL 126, which tracks, for example, the usage statistics of pages and requests the cache controller 130 to perform actions that may free up space in DRAM cache 700. For example, the cache controller 130 may be requested to compress an uncompressed LG (thereby changing the LG indicator field from “01” to “10”) or to remove an LG from the cache by flushing the LG into NAND (thereby changing the LG indicator field to “00”). These operations may be performed when the available free space within the DRAM cache 700 falls below a threshold. Whenever any operation results in a change to the DRAM cache space 700, the LG lookup table 800 and free list 136 may be updated.

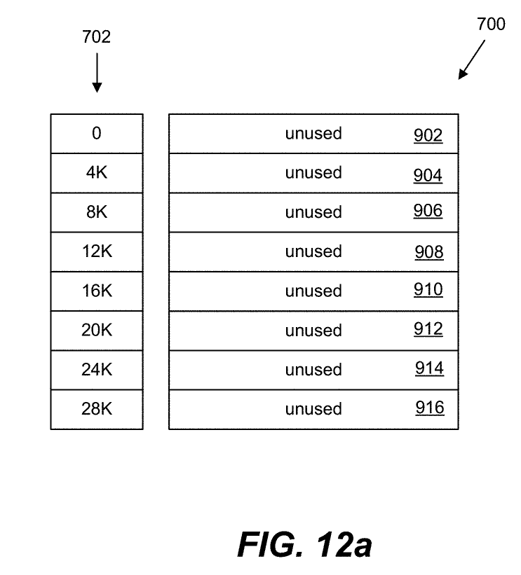

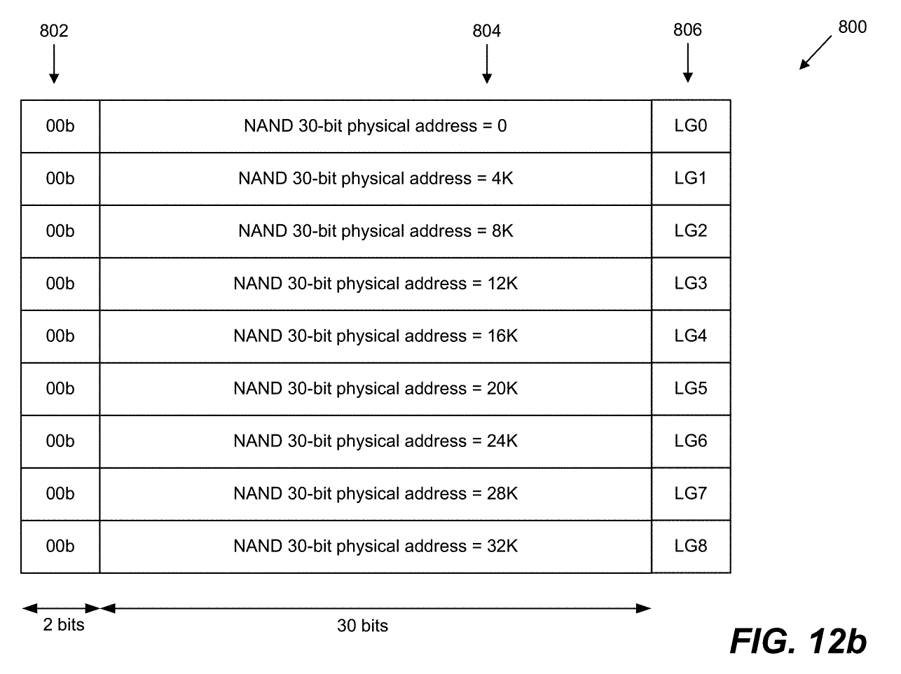

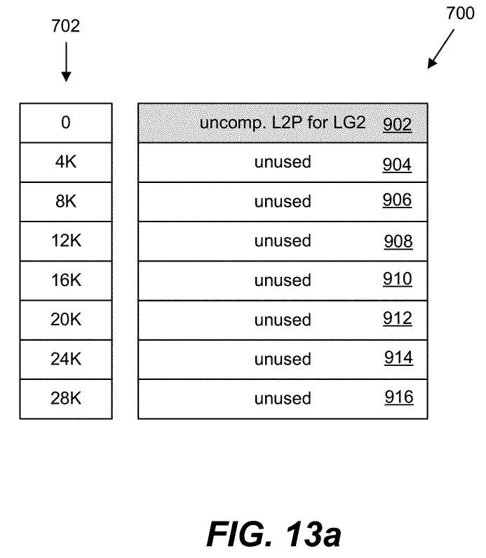

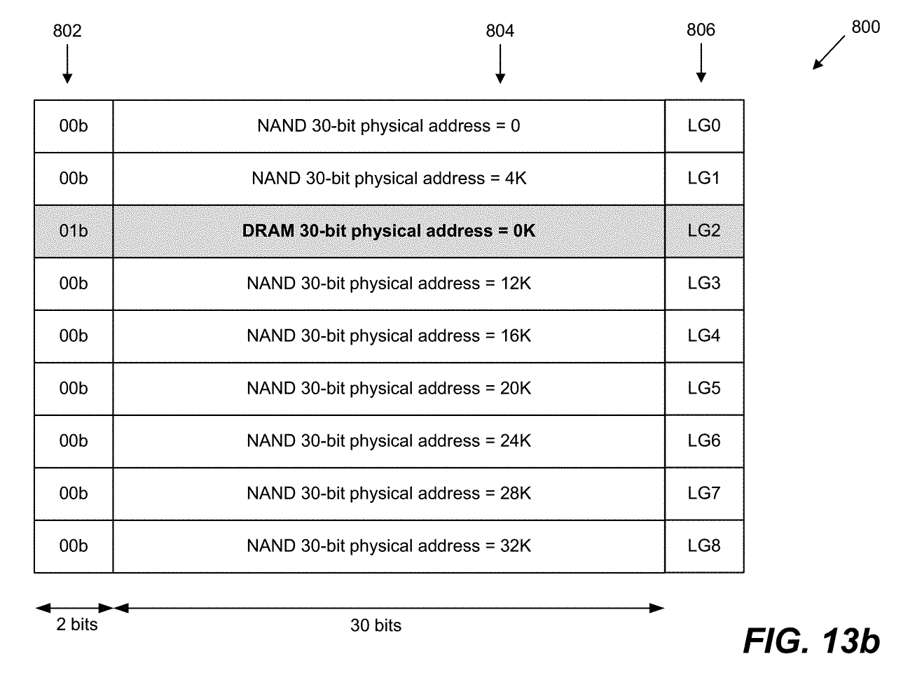

Various operational aspects of the DRAM cache space management will be further described in connection with the examples in FIGS. 12-18. FIG. 12a illustrates an initial state of a DRAM cache space 700 in which the entire space is unused (only the first 32 KB are shown). FIG. 12b depicts the matching LG lookup table 800 corresponding to this initial state 700 in which none of the indicator field 802 entries indicate DRAM. As illustrated in FIG. 12b, all of the indicator field 802 entries are “00”, which means that all of the logical groups are in NAND and not in DRAM (only rows LG0 thru LG8 in the full table are shown). In FIG. 13a, the first 4 KB of DRAM cache space 700 has been filled with the uncompressed L2P for LG2 902, and in FIG.13b the row corresponding to LG2 in LG lookup table 800 has been revised by updating both the indicator field 802 to “01” (formerly “00” in FIG. 12b) and the physical address 804 to “0K” (formerly “8K” in FIG.12b). It should be appreciated that this may occur as a result of a read or write transaction. For a read transaction, as described in connection with FIG. 10, the LG L2P may be cached from slower NAND into faster DRAM cache space 700. For a write transaction, as described in connection with FIG.11, the LG L2P may be stored into DRAM cache space 700.

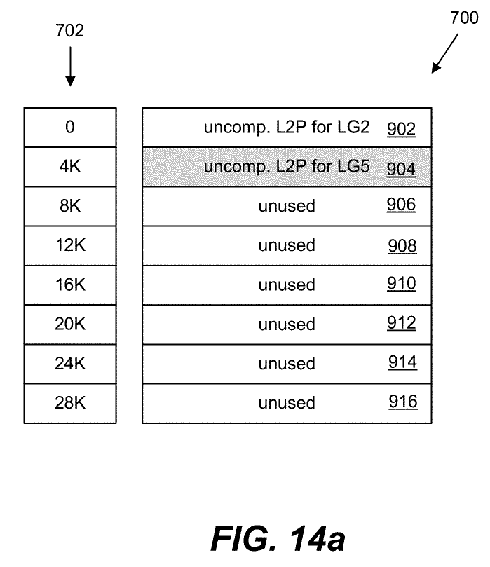

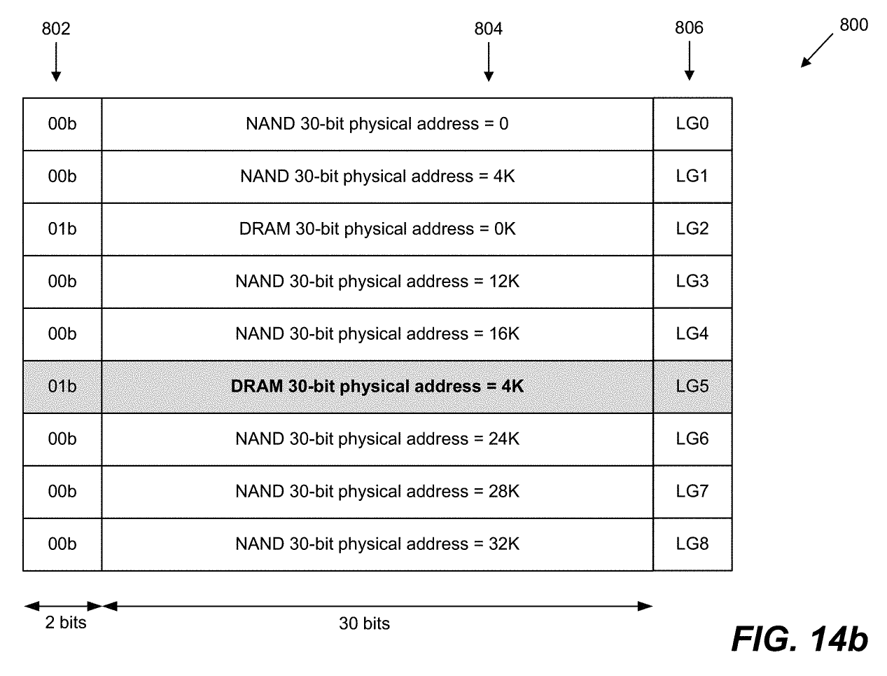

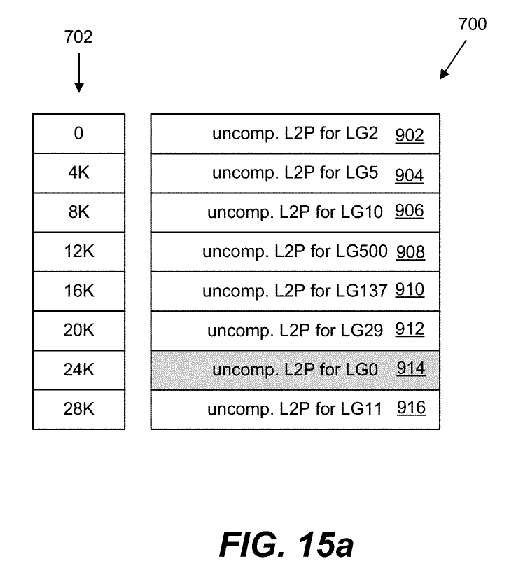

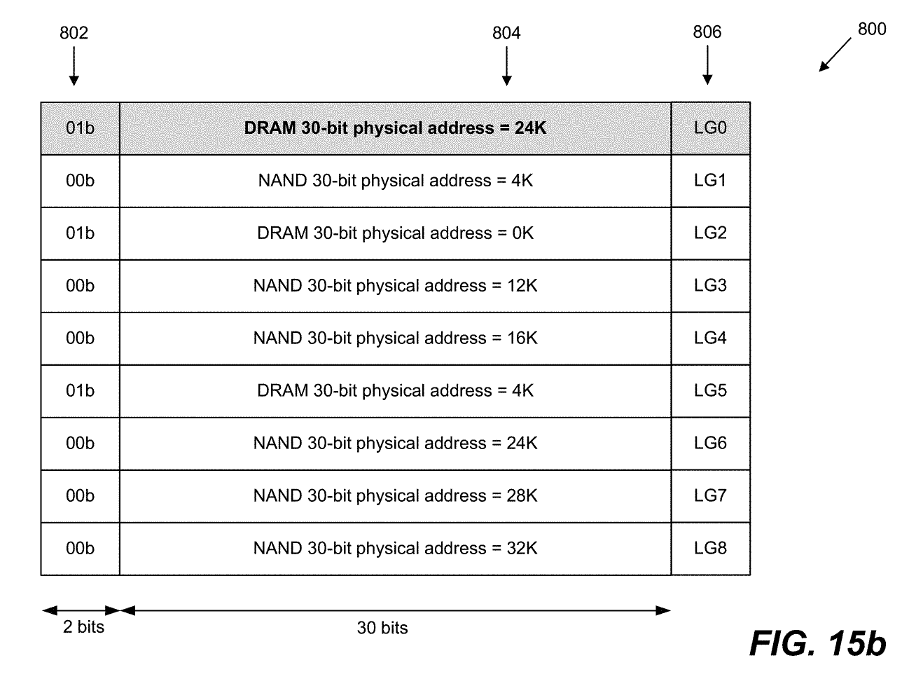

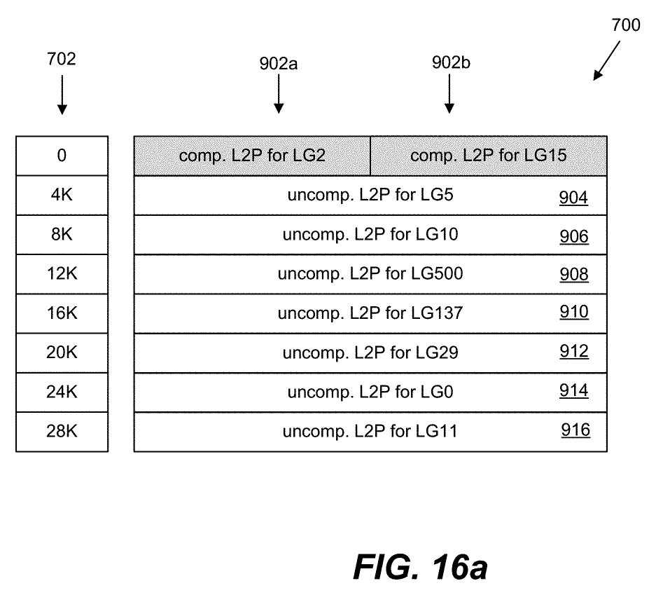

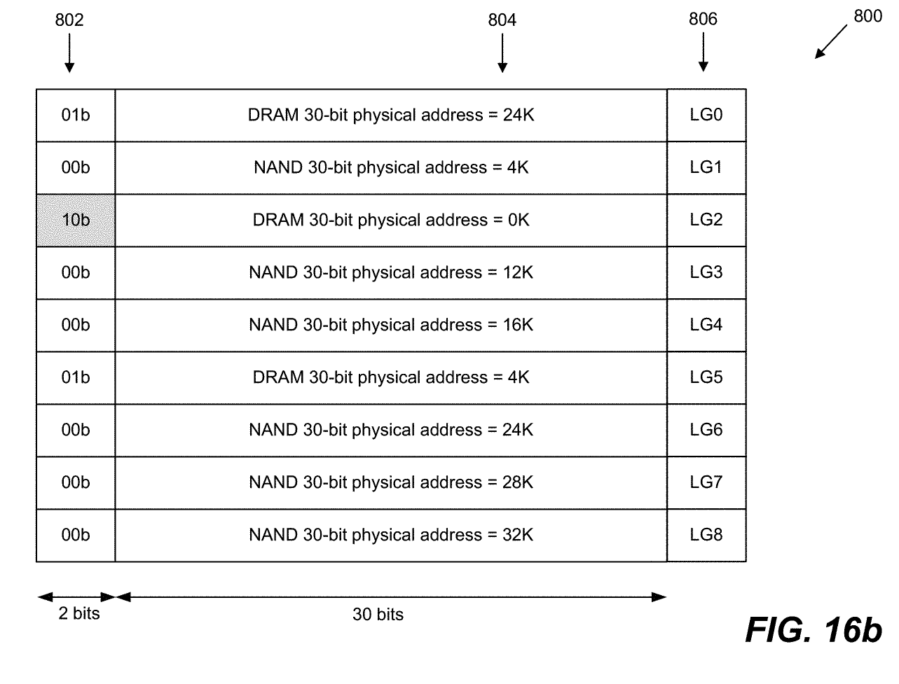

As illustrated in FIG. 14a, the L2P for LG5 904 may be added to DRAM cache space 700. In FIG. 14b, the row corresponding to LG5 in LG lookup table 800 has been revised by updating both the indicator field 802 to “01” (formerly “00” in FIG. 13b) and the physical address 804 to “4K” (formerly “20K” in FIG. 13b). FIG. 15a shows the addition of LG10 906, LG500 908, LG137 910, LG29 912, LG0 914, and LG11 916. Because only the first 9 logical groups (LG0 thru LG8) are shown in LG lookup table 800 in FIG. 15b, only LG0 in the first row is shown revised. The other logical groups (LG10, LG500, LG137, LG29, and LG11) may also be updated but just not illustrated in FIG. 15b. Referring to FIG. 15b, the row corresponding to logical group (LG0) in LG lookup table 800 has been revised by updating both the indicator field 802 to “01” (formerly “00” in FIG. 14b) and the physical address 804 to “24K” (formerly “0K” in FIG. 14b). Referring to FIG. 16a, two events may occur. First, the L2P for LG2 may be compressed to become 2 KB in size (formerly 4 KB) and re-written to address 0 902a. Second, the L2P for LG15 may be compressed and stored at address 2K 902b. In FIG. 16b, the row corresponding to LG2 in LG lookup table 800 has been revised by updating both the indicator field 802 to “10” (formerly “01” in FIG. 15b) but the physical address 804 remains “0K” since it still begins at address 0. LG15 is not visible in FIG. 16b, although the indicator field 802 and physical address 804 for LG15 may both be revised.

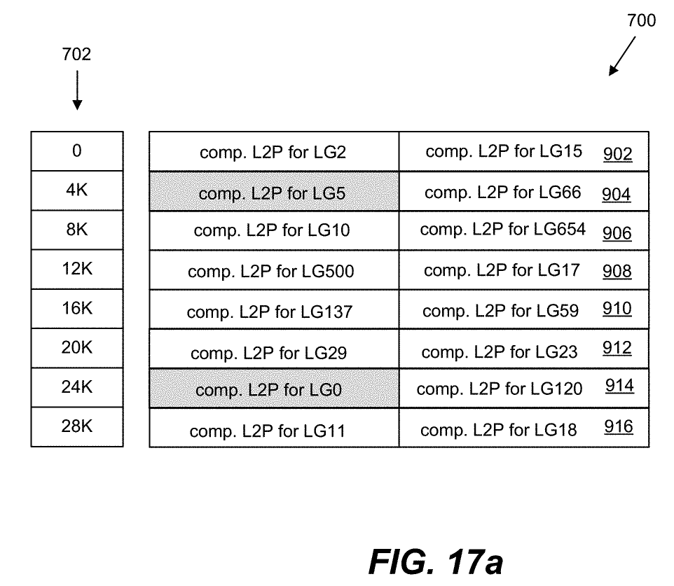

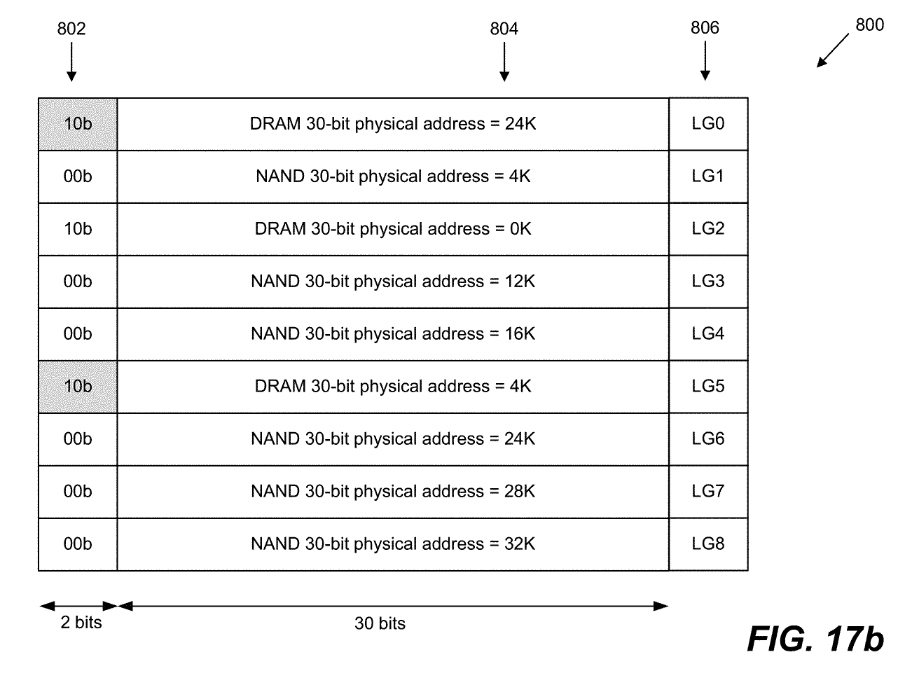

As illustrated in FIG. 17a, all of the L2P that were previously uncompressed and each occupying 4 KB may be compressed to 2 KB and re-written. In this manner, the space within DRAM cache space 700 may be increased, which allows new L2P for LG66, 904, LG654 906, LG17 908, LG59 910, LG23 912, LG120 914, and LG18 916 to be written. This illustrates the benefit of compression and reducing the maximum size needed for DRAM cache space 700. In FIG. 17b, the row corresponding to LG5 in LG lookup table 800 has been revised by updating both the indicator field 802 to “10” (formerly “01” in FIG. 16b) but the physical address 804 remains “4K” since it still begins at address 4K. LG66, LG654, LG17, LG59, LG23, LG120, and LG18 are not visible in FIG. 17b, although the indicator field 802 and physical address 804 are indeed revised to match their type (compressed “10”) and physical address within DRAM cache space 700.

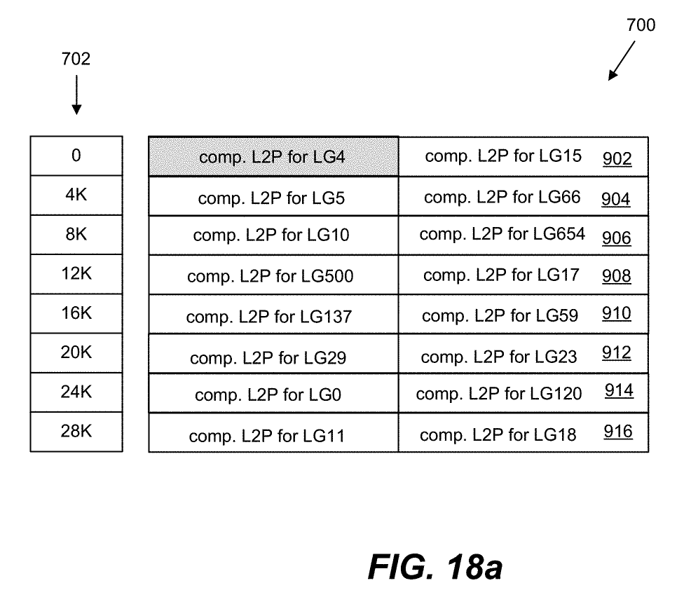

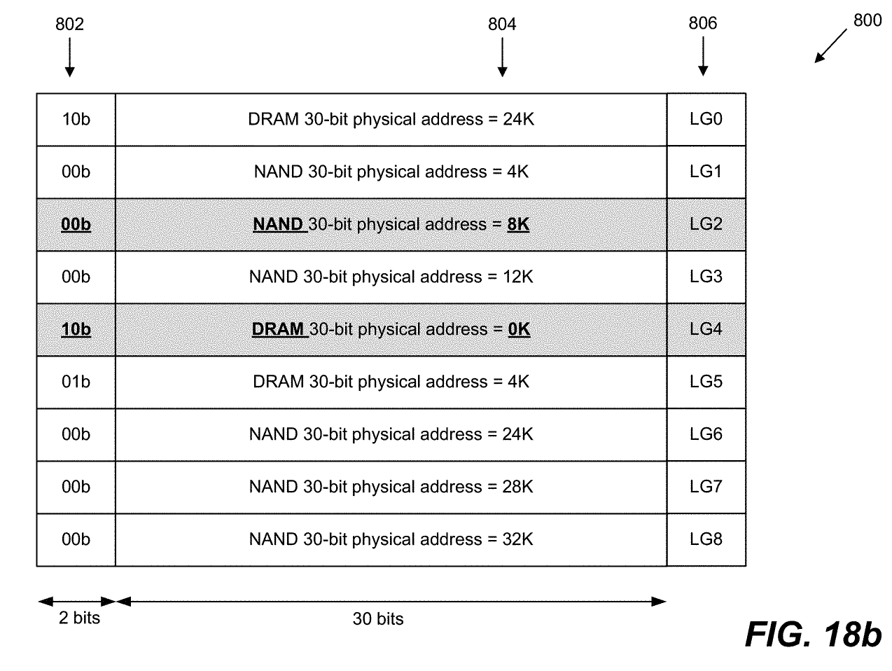

Referring to FIG. 18a, the L2P for LG2 has been removed from address 0, and the L2P for LG4 is written into the free space that was created by its removal. In FIG. 18b, the row corresponding to LG2 in LG lookup table 800 has been revised by updating both the indicator field 802 to “00” (formerly “10” in FIG. 17b) and the physical address 804 has been updated to “8K” (formerly “0K” in FIG. 17b). In addition, the row corresponding to LG4 in LG lookup table 800 has been revised by updating both the indicator field 802 to “10” (formerly “00” in FIG. 17b) and the physical address 804 has been updated to “0K” (formerly “16K” in FIG. 17b). It should be appreciated that these events may also affect and depend upon the free list 136. For example, in FIG. 18a, after the L2P for LG2 is removed from address 0, the least significant bit of the first row of the free list 136 (e.g., the first 2 KB of DRAM cache space 700 which starts at address 0) is zeroed to indicate that 2 KB beginning at address 0 is free in DRAM cache space 700. Then, when searching for free space to store the 2 KB L2P for LG4, the cache controller 130 may consult the free list 136, determine that there is 2 KB of free space at address 0, and then assign address 0 of DRAM cache space 700 to the L2P for LG4. After the 2 KB L2P for LG4 is written, the free list 136 may be updated to indicate there is no longer any free space at that location within DRAM cache space 700. It should be appreciated that, although multiple events may be depicted in the above Figures, each event may occur and be handled separately. For example, in FIG. 18a, the L2P for LG2 may be removed by the cache controller 130 at the request of the FTL 126 for the purpose of maintaining sufficient free space headroom within the DRAM cache space 700. In other words, LG2 may be removed prior to the need to cache LG4 arises.

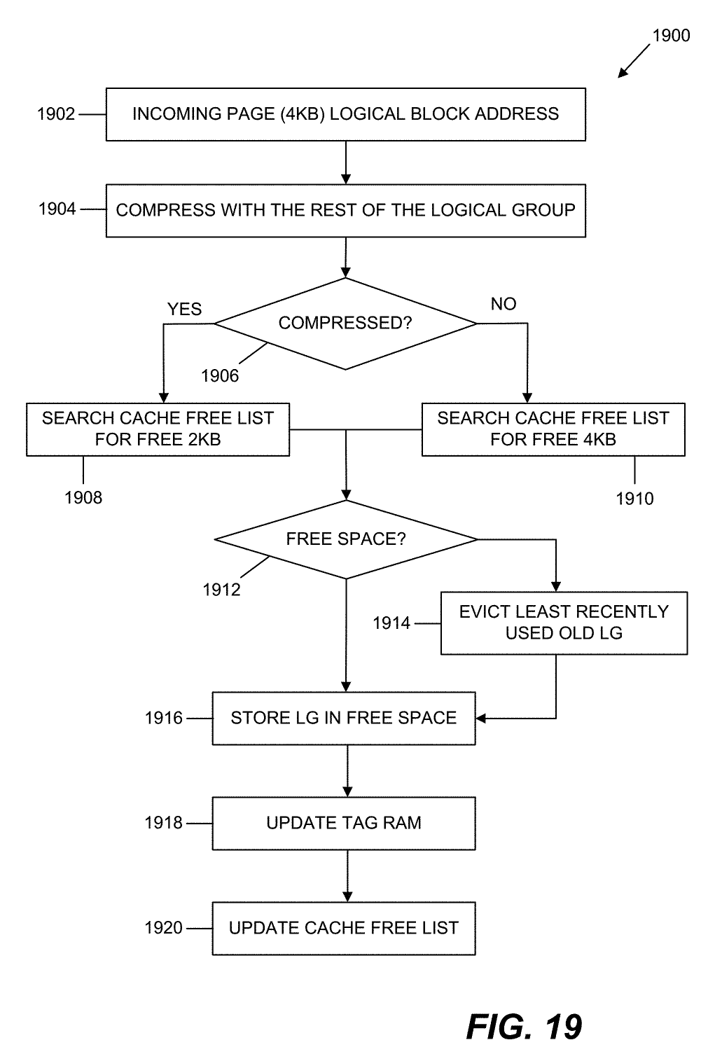

The flowchart 1900 in FIG. 19 illustrates the functionality performed by the cache controller 130 when compressing and caching a new L2P. In block 1902, a logical page address may need to be cached. In block 1904, the page L2P is merged with the other page L2P in the LG, and compression is performed. As mentioned above, in an embodiment, a logical group (LG) L2P may comprise the L2P for 1024 pages. In block 1906, the cache controller 130 determines if 2 KB is needed to store a compressed LG L2P or 4 KB is needed to store an uncompressed LG L2P. In blocks 1908 and 1910, the cache controller 130 searches the free list 136 for either free 2 KB or 4 KB, respectively. In block 1912, if free space is located, then in block 1916, the cache controller 130 stores the LG L2P in that free space. In block 1918, the LG lookup table 800 may be updated with the new indicator field 802 and physical address 804. In block 1920, the free list 136 may be updated to show that portion of the DRAM cache space is no longer free. However, if in block 1912 there is not any free space, then in block 1914 a stale LG may be removed to create free space. The old LG may be copied to NAND, and the LG lookup table for the old LG may be updated. The free list 136 may also be updated to show new space is now available. It should be appreciated that block 1914 may be avoided by proactive pruning of the DRAM cache space 700 where the FTL 126 keeps track of translations that are not recently used and then requests cache controller 130 to remove (i.e., copy from DRAM back into NAND) these old LG L2P from DRAM cache space 700.

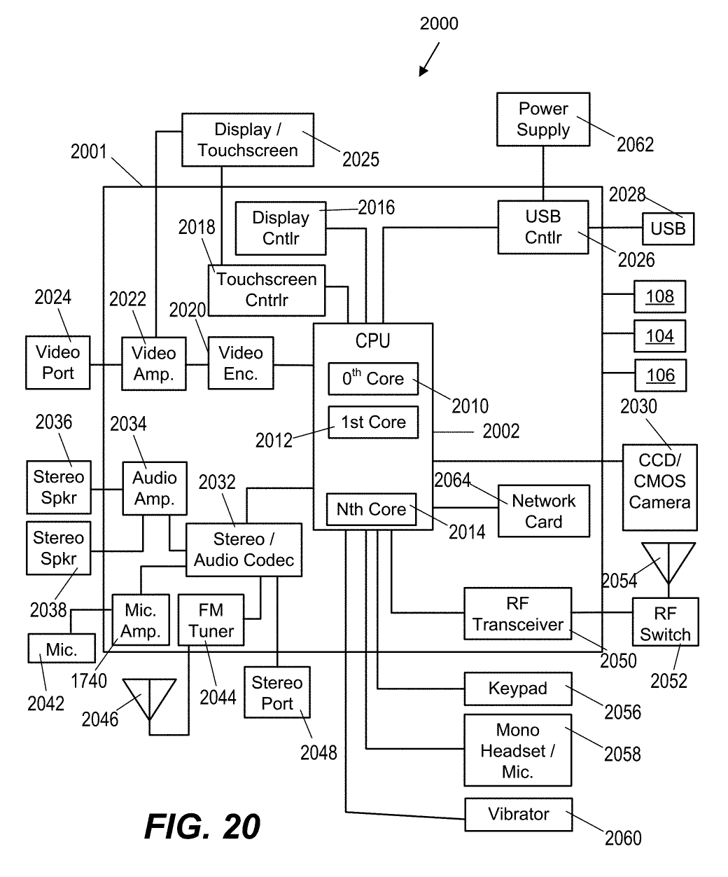

As mentioned above, the system 100 may be incorporated into any desirable computing system. FIG. 20 illustrates the system 100 incorporated in an exemplary portable computing device (PCD) 2000. The system 100 may be included on the SoC 2001, which may include a multicore CPU 2002. The multicore CPU 2002 may include a zeroth core 2010, a first core 2012, and an Nth core 2014. One of the cores may comprise, for example, a graphics processing unit (GPU) with one or more of the others comprising the CPU 104 (FIG. 1). According to alternate exemplary embodiments, the CPU 2002 may also comprise those of single core types and not one which has multiple cores, in which case the CPU 104 and the GPU may be dedicated processors, as illustrated in system 100.

A display controller 2016 and a touch screen controller 2018 may be coupled to the CPU 2002. In turn, the touch screen display 2025 external to the on-chip system 2001 may be coupled to the display controller 2016 and the touch screen controller 2018.

FIG. 20 further shows that a video encoder 2020, e.g., a phase alternating line (PAL) encoder, a sequential color a memoire (SECAM) encoder, or a national television system(s) committee (NTSC) encoder, is coupled to the multicore CPU 2002. Further, a video amplifier 2022 is coupled to the video encoder 2020 and the touch screen display 2025. Also, a video port 2024 is coupled to the video amplifier 2022. As shown in FIG. 20, a universal serial bus (USB) controller 2026 is coupled to the multicore CPU 2002. Also, a USB port 2028 is coupled to the USB controller 2026. Memory 110 and 118 and a subscriber identity module (SIM) card 2046 may also be coupled to the multicore CPU 2002. Memory 110 may comprise memory devices 110 and 118 (FIG. 1), as described above.

Further, as shown in FIG. 20, a digital camera 2030 may be coupled to the multicore CPU 2002. In an exemplary aspect, the digital camera 2030 is a charge-coupled device (CCD) camera or a complementary metal-oxide semiconductor (CMOS) camera.

As further illustrated in FIG. 20, a stereo audio coder-decoder (CODEC) 2032 may be coupled to the multicore CPU 2002. Moreover, an audio amplifier 2034 may coupled to the stereo audio CODEC 2032. In an exemplary aspect, a first stereo speaker 2036 and a second stereo speaker 2038 are coupled to the audio amplifier 2034. FIG. 20 shows that a microphone amplifier 1740 may be also coupled to the stereo audio CODEC 2032. Additionally, a microphone 2042 may be coupled to the microphone amplifier 1740. In a particular aspect, a frequency modulation (FM) radio tuner 2044 may be coupled to the stereo audio CODEC 2032. Also, an FM antenna 2046 is coupled to the FM radio tuner 2044. Further, stereo headphones 2048 may be coupled to the stereo audio CODEC 2032.

FIG. 20 further illustrates that a radio frequency (RF) transceiver 2050 may be coupled to the multicore CPU 2002. An RF switch 2052 may be coupled to the RF transceiver 2050 and an RF antenna 2054. As shown in FIG. 20, a keypad 2056 may be coupled to the multicore CPU 2002. Also, a mono headset with a microphone 2058 may be coupled to the multicore CPU 2002. Further, a vibrator device 2060 may be coupled to the multicore CPU 2002.

FIG. 20 also shows that a power supply 2062 may be coupled to the on-chip system 2001. In a particular aspect, the power supply 2062 is a direct current (DC) power supply that provides power to the various components of the PCD 2000 that require power. Further, in a particular aspect, the power supply is a rechargeable DC battery or a DC power supply that is derived from an alternating current (AC) to DC transformer that is connected to an AC power source.

FIG. 20 further indicates that the PCD 2000 may also include a network card 2064 that may be used to access a data network, e.g., a local area network, a personal area network, or any other network. The network card 2064 may be a Bluetooth network card, a WiFi network card, a personal area network (PAN) card, a personal area network ultra-low-power technology (PeANUT) network card, a television/cable/satellite tuner, or any other network card well known in the art. Further, the network card 2064 may be incorporated into a chip, i.e., the network card 388 may be a full solution in a chip, and may not be a separate network card.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for providing logical-to-physical address translation for a managed NAND flash storage device, the method comprising:
receiving, from a program executing on a system on chip (SoC), a logical address to be translated to a physical address associated with a managed NAND flash storage device electrically coupled to the SoC;
fetching, from a volatile memory device electrically coupled to the SoC, a portion of a logical-to-physical (L2P) address table comprising a compressed version of a L2P mapping for the logical address; and
decompressing the compressed version of the L2P mapping to determine the physical address corresponding to the logical address.

2. The method of claim 1, wherein the volatile memory device comprises a dynamic random access memory (DRAM).

3. The method of claim 1, wherein the portion of the L2P address table comprises a logical group corresponding to a plurality of pages.

4. The method of claim 3, wherein the fetching the portion of the L2P address table from the volatile memory device comprises determining the logical group via a look-up table.

5. The method of claim 1, wherein the receiving the logical address to be translated to the physical address corresponds to one of a write operation and a read operation.

6. The method of claim 1, further comprising:
accessing the physical address associated with the managed NAND flash storage device.

7. The method of claim 1, wherein the compressed version of the L2P mapping for the logical address comprises the L2P mapping for a plurality of pages comprising a logical group.

8. A computer program embodied in a non-transitory computer readable medium and configured to be executed to implement a method for providing logical-to-physical address translation for a managed NAND flash storage device, the method comprising:
receiving, from a program executing on a system on chip (SoC), a logical address to be translated to a physical address associated with a managed NAND flash storage device electrically coupled to the SoC;
fetching, from a volatile memory device electrically coupled to the SoC, a portion of a logical-to-physical (L2P) address table comprising a compressed version of a L2P mapping for the logical address; and
decompressing the compressed version of the L2P mapping to determine the physical address corresponding to the logical address.

9. The computer program of claim 8, wherein the volatile memory device comprises a dynamic random access memory (DRAM).

10. The computer program of claim 8, wherein the portion of the L2P address table comprises a logical group corresponding to a plurality of pages.

11. The computer program of claim 10, wherein the fetching the portion of the L2P address table from the volatile memory device comprises determining the logical group via a look-up table.

12. The computer program of claim 8, wherein the receiving the logical address to be translated to the physical address corresponds to one of a write operation and a read operation.

13. The computer program of claim 8, wherein the method further comprises:
accessing the physical address associated with the managed NAND flash storage device.

14. The computer program of claim 8, wherein the compressed version of the L2P mapping for the logical address comprises the L2P mapping for a plurality of pages comprising a logical group.

15. A system for providing logical-to-physical address translation for a managed NAND flash storage device, the system comprising:
means for receiving, from a program executing on a system on chip (SoC), a logical address to be translated to a physical address associated with a managed NAND flash storage device electrically coupled to the SoC;
means for fetching, from a volatile memory device electrically coupled to the SoC, a portion of a logical-to-physical (L2P) address table comprising a compressed version of a L2P mapping for the logical address; and
means for decompressing the compressed version of the L2P mapping to determine the physical address corresponding to the logical address.

16. The system of claim 15, wherein the volatile memory device comprises a dynamic random access memory (DRAM).

17. The system of claim 15, wherein the portion of the L2P address table comprises a logical group corresponding to a plurality of pages.

18. The system of claim 17, wherein the means for fetching the portion of the L2P address table from the volatile memory device comprises a cache controller configured to determine the logical group via a look-up table.

19. The system of claim 15, wherein the means for receiving the logical address to be translated to the physical address comprises a direct memory access (DMA) bus controller electrically coupled to the SoC.

20. The system of claim 15, wherein the received logical address corresponds to one of a write operation and a read operation.

21. The system of claim 15, further comprising:
means for accessing the physical address associated with the managed NAND flash storage device.

22. A system for providing logical-to-physical address translation for a managed NAND flash storage device, the system comprising:
a system on chip (SoC) electrically coupled to a volatile memory device;
a direct memory access (DMA) controller electrically coupled to the SoC for receiving a logical address to be translated to a physical address associated with a managed NAND flash storage device;
a cache controller configured to fetch from the volatile memory device a portion of a logical-to-physical (L2P) address table comprising a compressed version of a L2P mapping for the logical address; and
a compression block configured to decompress the compressed version of the L2P mapping to determine the physical address corresponding to the logical address.

23. The system of claim 22, wherein the volatile memory device comprises a dynamic random access memory (DRAM).

24. The system of claim 22, wherein the portion of the L2P address table comprises a logical group corresponding to a plurality of pages.

25. The system of claim 24, wherein the cache controller is configured to determine the logical group via a look-up table.

26. The system of claim 22, wherein the logical address to be translated to the physical address corresponds to one of a write operation and a read operation.

27. The system of claim 22, further comprising:
an interface for accessing the physical address associated with the managed NAND flash storage device.

28. The system of claim 22, wherein the compressed version of the L2P mapping for the logical address comprises the L2P mapping for a plurality of pages comprising a logical group.

29. The system of claim 22, incorporated in a portable computing device.

30. The system of claim 29, wherein the portable computing device comprises one of a smartphone or a table computer.
